(19) United States
(12) Patent Application Publication
(10) Pub. No.: US 2018/0018398 A1
(43) Pub. Date: Jan. 18, 2018

(54) POSITIONING CONTENT IN COMPUTER-GENERATED DISPLAYS BASED ON AVAILABLE DISPLAY SPACE

(71) Applicant: Cisco Technology, Inc., San Jose, CA (US)

(72) Inventor: Keith Griffin, Galway (IE)

(21) Appl. No.: 15/213,044

(22) Filed: Jul. 18, 2016

(51) Int. Cl. G06F 17/30; H04L 29/06; G06F 3/0484

(52) U.S. Cl. CPC G06F 17/30896; G06F 3/04845; H04L 65/403

(57) ABSTRACT

In an embodiment, a computer implemented method for a dynamic content positioning on a display of an electronic device based on available display space comprises: receiving, at a first computer, shared content that a second computer has shared with a plurality of computers; displaying the shared content on a display of the first computer in a shared area; receiving, at the first computer, self-view content from a camera coupled to the first computer; selecting a first area of the display of the first computer; determining whether the first area overlaps the shared area; in response to determining that the first area overlaps the shared area, determining whether the display has an available different area that does not overlap the shared area and that has a specified size, and in response to determining such an available different area, displaying the self-view image content in the available different area.

### TECHNICAL FIELD

The present disclosure generally relates to computer methods and systems that are programmed or configured to automatically position graphical content in computer-generated displays of computer devices based on available display spaces, such as in videoconferencing systems. SUGGESTED GROUP ART UNIT: 2447; SUGGESTED CLASSIFICATION: 709.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Many electronic devices allow displaying contents received from different computer devices and different users. For example, some Web and video conferencing applications allow displaying, on a computer display, a plurality of video inputs that have been concurrently received from a plurality of computer devices. Smartphone video chat applications, such as a Facetime application, allow displaying, on a phone display, depictions of two individuals engaged in a telephone conversation. Very often, however, the contents displayed on the display may obscure each other. For example, when two users participate in a video conference call and share some content during the conference, the user's device may display a self-view image of the user as obscuring the display of the shared content. On some systems it may be possible to manually reposition the self-view on the display; however, a frequent repositioning of the self-view may negatively impact the user's experience of using the device.

### SUMMARY

The appended claims may serve as a summary of the invention.

### BRIEF DESCRIPTION OF THE DRAWINGS

In the drawings:

FIG. 1 illustrates an example networked environment with a plurality of computer devices, servers, databases and other sources providing contents to computer devices according to an example embodiment.

FIG. 2 illustrates a signal pipeline providing contents from a plurality of sources to a computer device.

FIG. 3 is a screen snapshot of a display of a display device that shows self-view content obscuring shared content.

FIG. 4 is a screen snapshot of a display of a display device that shows an available area on the display.

FIG. 5 is a screen snapshot of a display of a display device that shows repositioning of self-view content to an available area on the display.

FIG. 6 illustrates a process for a dynamic content positioning, or repositioning, on a computer-generated display of a display device.

FIG. 7 illustrates a process for a dynamic content positioning, or repositioning, on a computer-generated display of a display device using a content resizing approach.

FIG. 8 illustrates a process for a dynamic content positioning, or repositioning, on a computer-generated display of a display device using a content cropping approach.

FIG. 9 illustrates a process for a dynamic positioning, or repositioning, of additional content on a computer-generated display of a display device.

FIG. 10 is a picture showing a plurality of displays in which contents are dynamically positioned and repositioned.

FIG. 11 is a screen snapshot of a display of a smartphone that shows contents positioned using a process for a dynamic content positioning, or repositioning, on a computer-generated display of a display device.

FIG. 12 illustrates a computer system upon which an embodiment of the invention may be implemented.

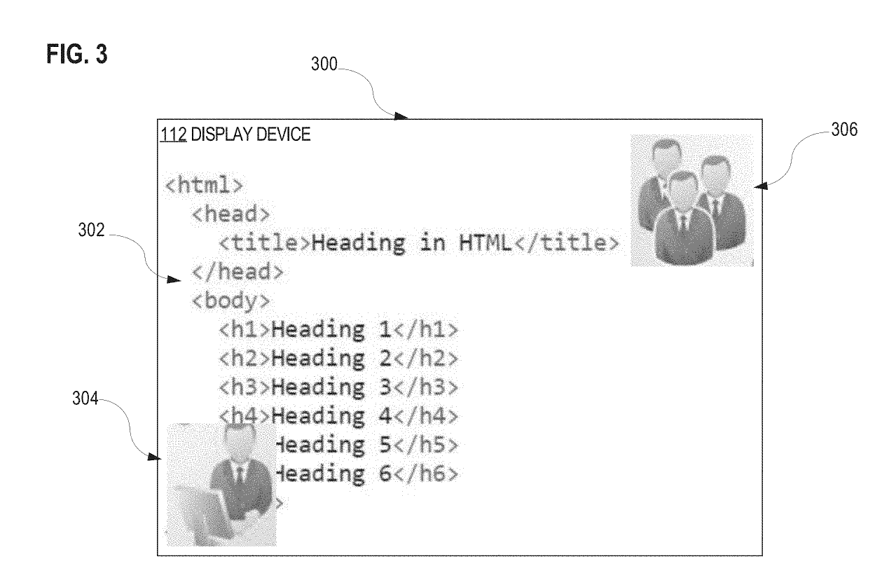

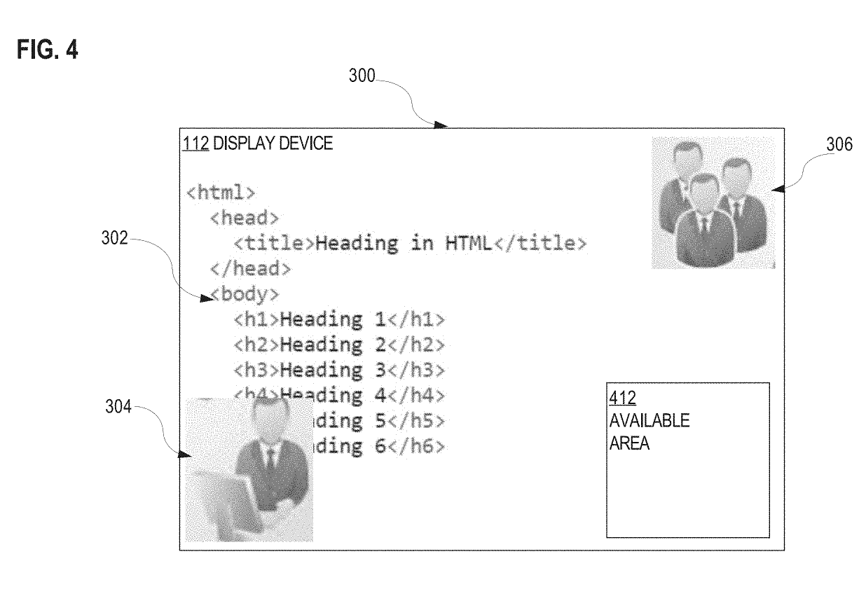

While each of the drawing figures illustrates a particular embodiment for purposes of illustrating a clear example, other embodiments may omit, add to, reorder, or modify any of the elements shown in the drawing figures. For purposes of illustrating clear examples, one or more figures may be described with reference to one or more other figures, but using the particular arrangement illustrated in the one or more other figures is not required in other embodiments. For example, self-view content 304 and shared content 302 in FIG. 3 may be described with reference to several steps in FIGS. 4-5 and 9, and discussed in detail below, but using the particular arrangement illustrated in FIG. 3 is not required in other embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. Furthermore, words, such as “or,” may be inclusive or exclusive unless expressly stated otherwise.

Embodiments are described herein according to the following outline:
1.0 General Overview
2.0 Example Network Topology for Dynamic Content Positioning on Computer-Generated Displays Based on Available Display Space
3.0 Example Content Delivery Pipeline
4.0 Process for Dynamic Content Positioning Based on Available Display Space
   4.1 Example of Displaying Self-view Content in Available Area
   4.2 Example of Content Resizing
   4.3 Example of Content Cropping
   4.4 Extensions
   4.5 Benefits of Certain Embodiments
5.0 Implementation Mechanisms—Hardware Overview
6.0 Other Aspects of Disclosure

### 1.0 General Overview

In one aspect, the present disclosure provides computer-implemented techniques for dynamic positioning of contents on computer-generated displays based on available display space. “Dynamic,” in this context, may mean that the contents are automatically moved to different positions in the display based upon display space that is available for the contents, and based upon other image elements that are displayed in other parts of the display. A computer device that generates a display may be any type of a device configured to receive and display digital data and digital images. Examples of such devices may include desktops, laptops, smartphones, personal digital assistants, and any other types of computer devices.

Contents dynamically positioned on computer-generated displays may include contents that are shared by multiple computers and contents that are not shared. Contents shared by computers are referred to as shared contents. Examples of shared contents may include shared video conference contents. Shared contents may be generated by for example, videoconference applications, picture-in-picture applications, video collaboration applications, mobile calling applications, video and audio collaboration applications, video chat applications, or shared desktop applications. Shared contents may be provided to a computer device by cameras, computer servers, or other computing devices.

Contents that are not shared by computers are referred to as non-shared contents. Non-shared contents may include, for example, a self-view image of a user or a particular image that a user selected as his avatar. A self-view image may be an image captured by a camera, and displayed on the user's display device as the user participates in a collaboration session with another user.

Shared contents and non-shared contents may be concurrently displayed on a computer-generated display. For example, shared contents that users share and a self-view image of a user may be concurrently displayed on a display generated by a computer device of the user.

From a network implementation perspective, dynamic positioning of contents on a display of a display device based on available display space may be implemented using a client computer, a server computer, or both. In implementations on a client computer, positions for displaying the contents within a display are determined by a client device. In implementations on a server computer, positions for displaying the contents within a display are determined by a server device.

In some situations, the approach may be implemented on both a client computer and a server computer. This may be useful when some contents are merged on a server computer and some are merged on a client computer. For example, a server device may determine positions for displaying two or more shared video contents and merge them into one merged content, while a client device may determine a position for displaying the user's self-view when both the merged content and the self-view are displayed on the user's device.

In an embodiment, an approach for a dynamic content positioning of contents on computer-generated displays includes receiving shared content at a first computer, and displaying the shared content on a display of the first computer in a shared area. Shared content may be content that a second computer shares with the first computer during a video conference.

The first computer may also receive self-view content. Self-view content may be a video signal received from a camera coupled to the first computer. The first computer may select a first area within a display of the first computer, and determine whether the self-view content may be displayed in the first area. This may be determined by testing whether the first area overlaps the shared area on the display.

In an embodiment, if the first area overlaps the shared area, then a test is performed to determine whether the display has an available area that does not overlap the shared area and that has a specified size. In response to determining that such an available area exists, the self-view content is displayed in the available area.

In an embodiment, in response to a change in the shared content that causes the first area to overlap the changed shared content, another different area is determined, and, only after expiration of a timer having a specified time value, the self-view content is displayed in the another different area.

In an embodiment, an approach for a dynamic content positioning on computer-generated displays based on available display space includes receiving, at a first electronic device, shared content that a second device has shared with a plurality of computer devices, and displaying the shared content on a display of the first electronic device in a shared area.

The first electronic device may also receive self-view content from a camera coupled to the first electronic device, and determine a first area for displaying the self-view content.

In an embodiment, a test is performed to determine whether the first area of the display of the first electronic device overlaps the shared area. If the first area overlaps the shared area, then an additional test is performed to determine whether the display has an available area that does not overlap the shared area. An available area may include for example, an area of the display that is not used to display any content. An available area may be determined using a white space detection approach, a free space detection, a Gaussian blur method, a Sobel operator method, a medial filter method, a pixel-based analysis, or others.

In an embodiment, in response to determining an available area that does not overlap the shared area, the self-view content is displayed in the available different area. However, if the available different area overlaps the shared area, then a test is performed to determine whether the self-view content can be resized to self-view resized content. If the self-view content can be resized, then the self-view resized content is displayed in the available area.

However, if the self-view content cannot be resized to the self-view resized content, then a test is performed to determine whether the shared content can be resized to shared resized content, and if it can, then the shared resized content is displayed in a shared resized area.

In an embodiment, if the shared content cannot be resized to the shared resized content, then a test is performed to determine whether the self-view content can be cropped, and if it can, then self-view cropped content is displayed in a self-view cropped area. But, if the self-view content cannot be cropped, then an additional test is performed to determine whether the shared content can be cropped. In response to determining that the shared content can be cropped, shared cropped content is displayed in a shared cropped area.

In an embodiment, in response to determining that the shared content cannot be cropped to the shared cropped content, the self-view content is displayed in the first area as overlapping the shared content displayed in the shared area. Additionally, a message or a warning may be displayed on the display of the electronic device.

### 2.0 Example Network Topology for Dynamic Content Positioning on Computer-Generated Displays Based on Available Display Space

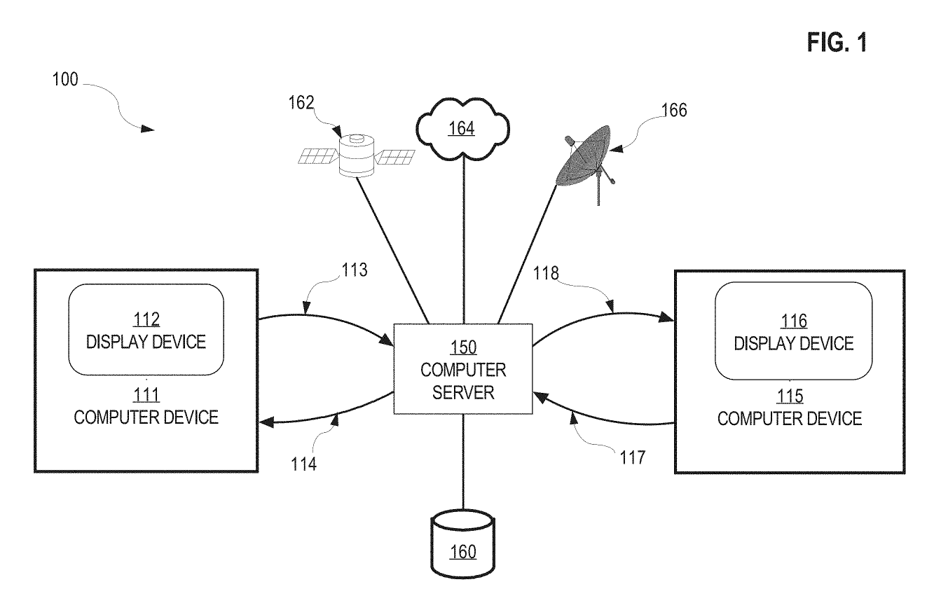

FIG. 1 illustrates an example networked environment 100 with a plurality of computer devices, servers, databases and other sources providing contents to computer devices according to an example embodiment. In FIG. 1, networked environment 100 comprises two or more computer devices 111, 115, and one or more computer servers 150. Computer devices 111, 115 may be operatively coupled to computer server 150 over one or more computer networks as depicted in FIG. 1, or directly coupled with each other over direct communications links (not depicted in FIG. 1).

Computer devices 111, 115 may be any type of devices such as a desktop device, a communications device, a mobile device, a smartphone device, a personal digital assistant (PDA), or any type of device configured to receive and display contents. Any reference to “a computer device” herein may mean one or more devices, unless expressly stated otherwise. Computer devices 111, 115 may also be referred to as electronic devices.

Computer devices 111, 115 may comprise display devices 112, 116, respectively. Display devices 112, 116, also referred to as displays, are used to display contents provided to computer devices 111, 115. Content provided to display devices 112, 116 may include two or more components, and each component may be displayed in a particular area of the display.

Contents may include any type of electronic data that can be displayed on display devices 112, 116 of computer devices 111, 115. Contents may be provided as a video stream, a video signal, a stream of images, or any other data input capable of carrying image data. Contents may include for example, a signal or a data stream carrying electronic data representing documents shared by computers, or a signal or a data stream carrying electronic data representing a self-view image.

Computer devices 111, 115 may be configured to execute various applications to facilitate receiving contents, determining positions for displaying the received content on displays 112, 116, respectively, and displaying the received contents in the determined positions on displays 112, 116. For example, computer device 111 may receive shared content from computer device 115, display the received shared content on display 112, receive a self-view image of a user of computer device 111, and display the self-view on display 112.

Computer device 111 may be configured to send contents to computer server 150 via communications link 113, and receive contents from computer server 150 via a communications link 114. Computer device 115 may send contents to computer server 150 via communications link 117, and receive contents from computer server 150 via communications link 118. Computer devices 111, 115 may also communicate with each other directly and send contents to each other via direct links (not depicted in FIG. 1).

In an embodiment, computer server 150 receives contents from computer devices 111, 115, and communicates the received contents to the contents' recipients. For example, computer server 150 may receive contents from computer device 111 via communications link 113, and communicate the received contents to computer device 115 via communications link 118. Computer server 150 may also receive contents from computer device 115 via communications link 117, and communicate the received contents to computer device 111 via communications link 114.

Computer server 150 may also receive contents from one or more databases 160, one or more satellite devices 162, one or more cloud storage systems 164, one or more satellite dishes 166, one or more roaming towers (not depicted in FIG. 1), or any other data communications devices.

### 3.0 Example Content Delivery Pipeline

Computer devices 111, 115 may receive any type of contents that can be displayed on displays 112, 116, respectively. Contents may for example, include a signal or a data stream carrying electronic data representing a self-view image of a user of computer device 111, as well as one or more signals carrying electronic data representing shared contents, such as a shared document.

A self-view image, also referred to as self-view content, may be captured by a camera communicatively coupled to computer device 111, or computer device 115. Shared contents may include a signal or a data stream carrying electronic data representing dynamically updated content shared between computers. Shared content may be any type of signal generated a videoconference application, a picture-in-picture application, a video collaboration application, a mobile calling application, a video and audio collaboration application, a video chat application, or any other shared desktop application.

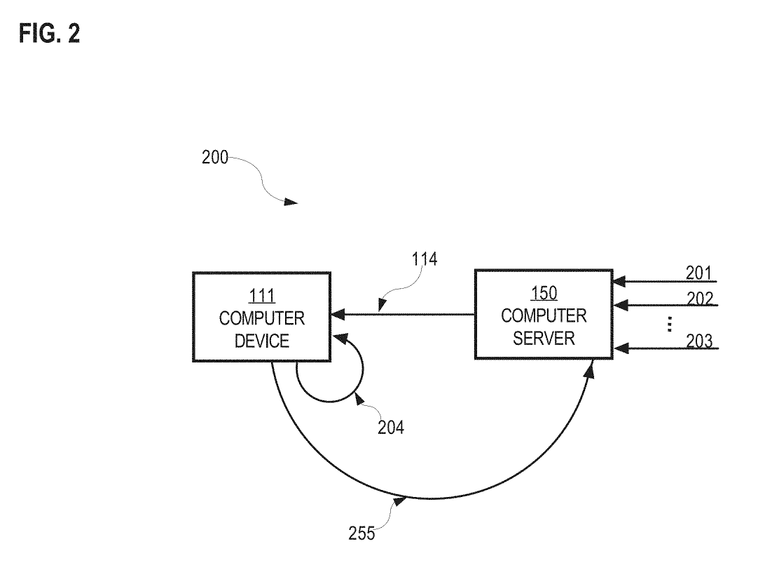

FIG. 2 illustrates a signal pipeline 200 providing contents from a plurality of computers to computer device 111. In FIG. 2, pipeline 200 comprises computer server 150, communications link 114, and computer device 111. Computer server 150 receives one or more input signals 201, 202, 203, each of which may be generated by an individual computer device, such as computer device 115, provided by a satellite, or by any other signal source. For example, computer server 150 may receive input signal 201 generated by computer device 115, input signal 202 from a satellite, and input signal 203 from a smartphone application. According to another example, computer server 150 may receive input signals 202, 202 and 203 that are to be shared among computer devices 111, 115.

Although FIG. 2 depicts three input signals 201, 202, 203, computer server 150 may be configured to receive any number of input signals.

Computer server 150 may transmit input signals 201, 202, 203 to computer device 111 via communications link 114. Upon receiving the inputs from server 150 via communications link 114, computer device 111 may determine areas within a display space of display device 112 of computer device 111 for displaying the content provided by input signals 201, 202, 203.

Computer server 150 may transmit each of the received input signals to computer device 111, or may merge the received input signals into merged content and transmit the merged content to computer device 111. For example, computer server 150 may process input signals 201, 202, 203, and generate for example, a composite, merged content. The merged content may be transmitted from server 150 to computer device 111 via communications link 114 (as depicted in FIG. 2), or via any other communications link. Upon receiving the merged content from server 150, computer device 111 may determine an area within a display of display device 112 of computer device 111 for displaying the merged contents.

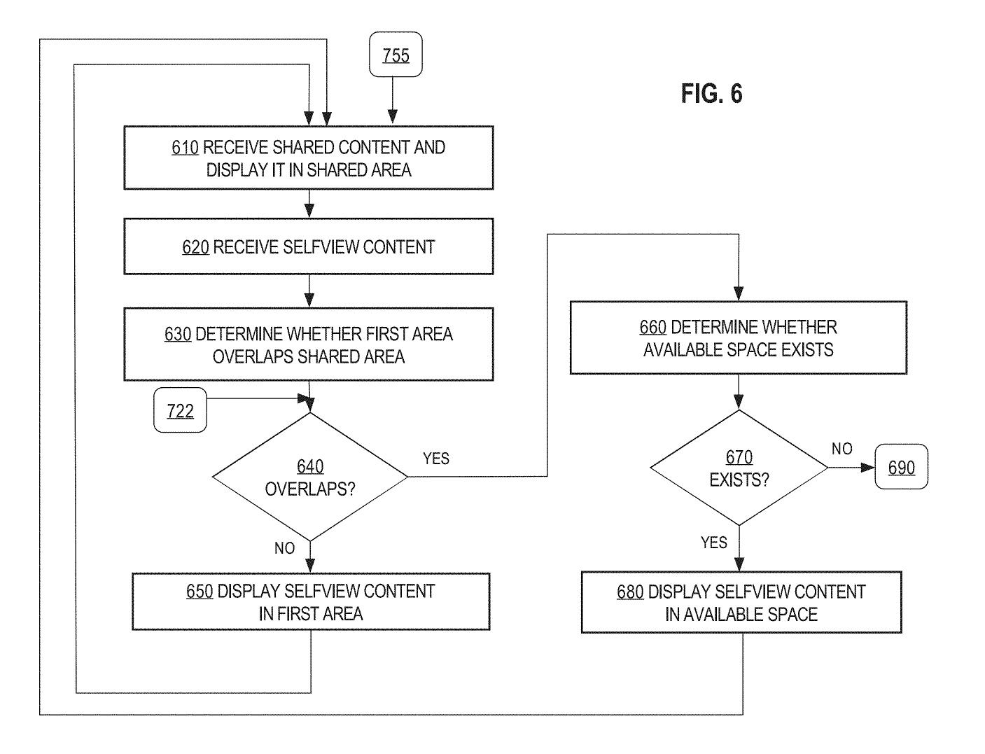

In an embodiment, computer device 111 is equipped with a camera configured to capture self-view images of a user. Self-view images are also referred to as self-view content or just self-view. Self-view may include a stream of images depicting a user of computer device 111. Self-view content may be directly provided to computer device 111, or transmitted to computer device 111 via communications link 204, as depicted in FIG. 2. Upon receiving the self-view content, computer device 111 dynamically determines a position within a display of display device 112 for displaying the self-view content. The process of determining the position for displaying the self-view content is described in detail in FIG. 6.

In an embodiment, computer device 111 generates shared content and transmits the shared content to computer server 150 via communications link 255, as depicted in FIG. 2. Upon receiving the shared content from computer device 111, computer server 150 may transmit the shared content to computer device 115. Computer server 150 may also transmit the shared content to other devices such as database 160, satellite device 162, cloud storage system 164, satellite dish 166, or any other data communications devices. Those devices may then transmit the shared content to other user devices or servers.

### 4.0 Process for Dynamic Content Positioning Based on Available Display Space

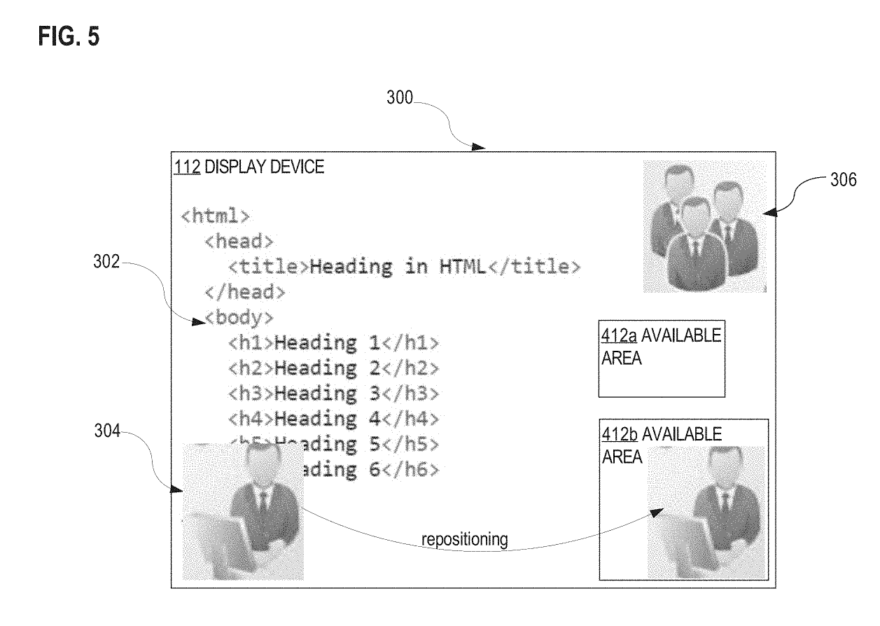

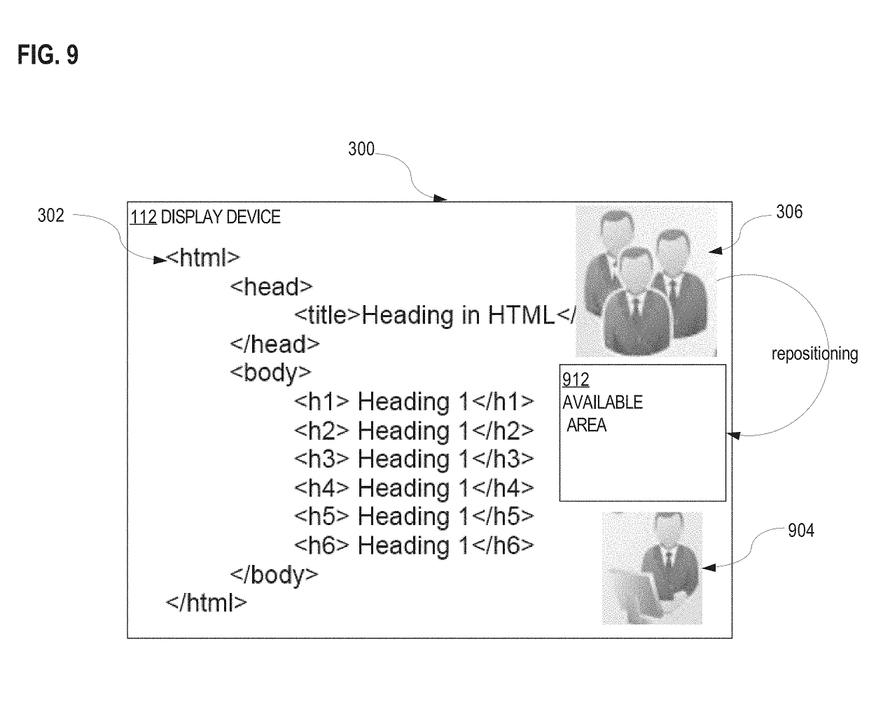

Dynamic positioning of contents on a computer-generated display based on available display space may be applicable to a variety of video collaboration sessions. An example implementation may be illustrated using an active presence example. In an active presence session, users can share contents and the shared contents are usually displayed in a central portion of a display of a display device. In addition to displaying the shared content, the display device may also display a self-view image of the user. Furthermore, or optionally, the display device may display depictions of other users who participate in the video conference, or any other shared or non-shared content. However, displaying all that on one display is usually challenging, especially when the display is small. One of the problems may be that displays of some contents may obscure each other on the display. Another problem may be that displays of some contents may be very small, and thus hard to read. Examples of some problems are described in FIG. 3 and FIG. 9. Examples of solutions based on a dynamic content positioning are described in FIG. 4-5.

FIG. 3 is a screen snapshot of display 300 of display device 112 that shows self-view content 304 obscuring shared content 302. Self-view content 304 may represent a self-view of a user of a computer device, such as computer device 111 or 115. Self-view content 304 may also be an avatar image that a user selected as his graphical representation. Shared content 302 represents any content that computers and users participating in a collaboration session are sharing. For example, shared content 302 may be an HTML documents that the users discuss or review during a videoconference collaboration session.

In the example depicted in FIG. 3, self-view content 304 appears to obscure a portion of shared content 302. As it may be gleaned from FIG. 3, self-view content 304 obscures a left lower portion of shared content 302. Thus a user of display device 112 cannot easily read that portion of shared content 302. Assuming that reading the entire shared content 302 displayed on display device 112 is important to the user, the user would prefer if self-view 304 was displayed at for example, a right lower corner of display 300 because no content appears to be displayed in the right lower corner of display 300. Repositioning self-view content 304 to some available area on display 300 may be desirable to maximize, or enhance, the user's experience as the user participates in the collaboration session.

In an embodiment, computer device hosting display device 112 automatically determines whether self-view content 304 could be positioned at, or repositioned to, an available area within display 300 so that self-view content 304 does not overlap shared content 302. An example of the process for determining one or more available areas within display 300 for positioning, or repositioning, self-view content 304 so that self-view content 304 does not overlap shared content 302 is described in FIG. 4.

FIG. 4 is a screen snapshot of display 300 of display device 112 that shows an available area 412 on display 300. Some displays, like display 300 depicted in FIG. 4, are configured to display not only self-view content 304 and shared content 302, but also additional shared or non-shared contents 306. In the example depicted in FIG. 4, shared content 306 includes depictions of other users who collaborate with the user of display device 112.

In FIG. 4, self-view content 304 overlaps shared content 302, which in this example is an HTML document. Because self-view content 304 overlaps shared content 302, reading the HTML document may be difficult. To enhance the user's experience in participating in a collaboration session, the user of display device 112 would like to have his self-view content 304 moved to some other area, such as available area 412.

An “available” area is an area identified in display 300 of display device 112 that is not used to display any shared or non-shared content in a given moment. In the example depicted in FIG. 4, an available area may be an area that does not overlap any of shared content 302, self-view content 304, or depictions 306. In FIG. 4, available area 412 is positioned at a lower right corner of display 300, while shared content 302 is positioned at the upper left corner of display 300, self-view content 304 is positioned at the lower left corner of display 300, and depictions 306 are positioned at the upper right corner of display 300.

The process of determining an available area may provide any of three answers: there is no available area on a display, there is one available area on a display, or there is a plurality of available areas on a display. In an embodiment, no available area for positioning, or repositioning, self-view content 304 is identified in display 300. This may happen when for example, one or more shared contents filled up the entire display 300. In such situations, it may be difficult to position, or reposition, self-view content 304 to some other area within display 300.

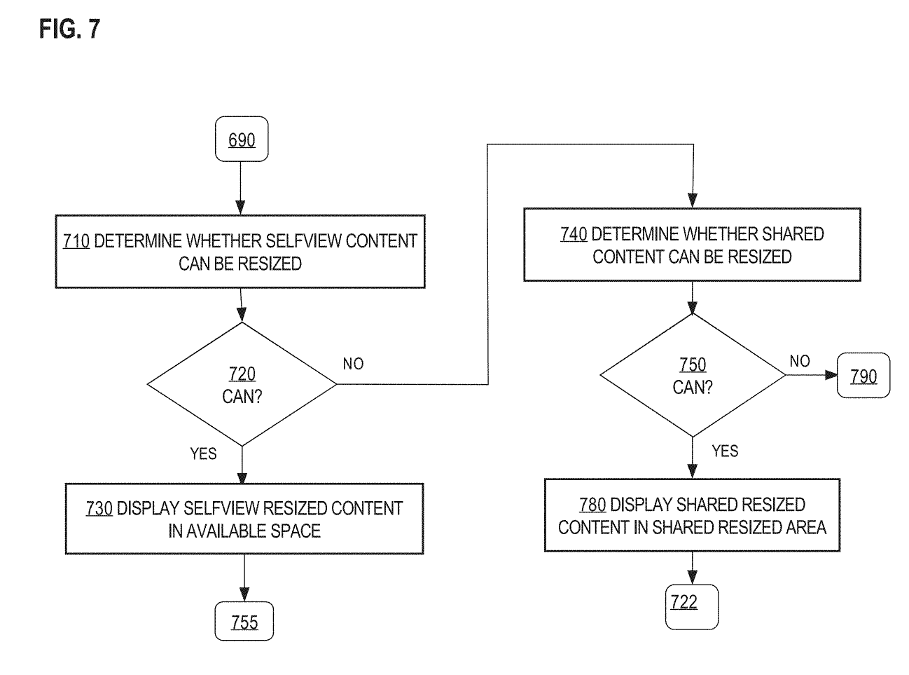

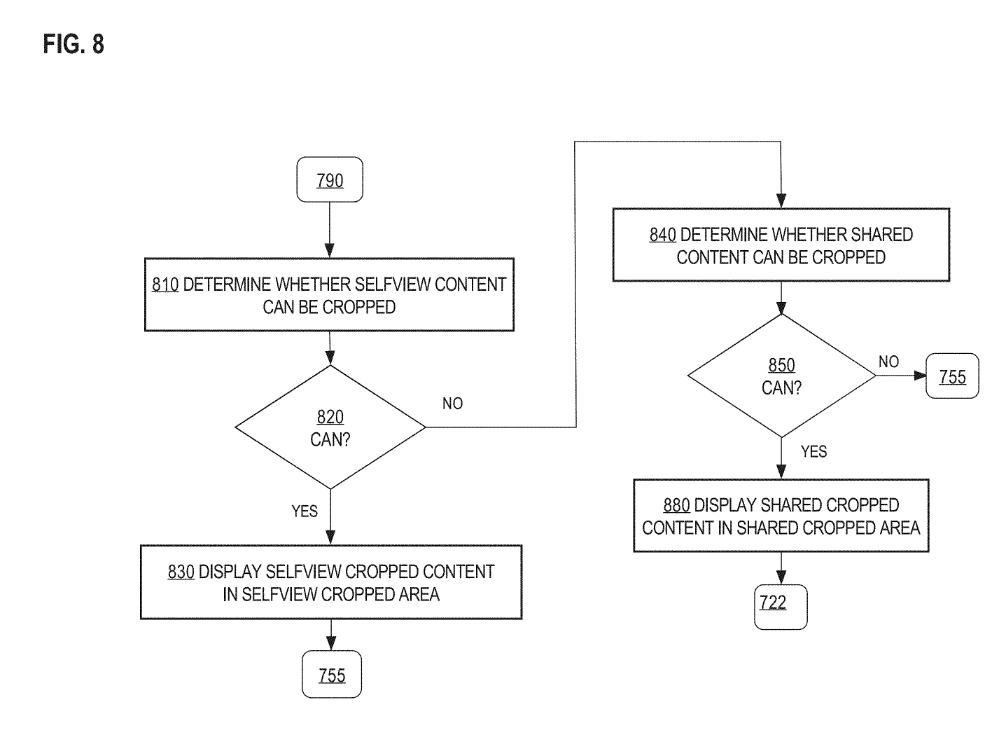

In an embodiment, if no available area is available for positioning, or repositioning, self-view content 304, then a computer system may attempt to for example, resize or crop the displays of self-view content 304 or shared content 302, and then determine whether any available area for positioning, or repositioning, self-view content 304 may be found. Examples of this approach are described in FIG. 7-8.

In an embodiment, only one available area 412 is identified in display 300. This embodiment is depicted in FIG. 4. Once available area 412 is identified, the computer system automatically determines whether self-view content 304 may be moved to available area 412. This may be accomplished using a variety of approaches. For example, a computer system may try to compare the size of self-view content 304 and the size of available area 412 to determine whether available area 412 is large enough for displaying self-view content 304. If the computer system determines that available area 412 is large enough for displaying self-view content 304, then the computer system may dynamically and automatically position, or reposition, self-view content 304 to available area 412.

However, if the computer system determines that self-view content 304 does not fit in the space identified as available area 412, then a computer system may attempt to for example, resize or crop the display of self-view content 304 or shared content 302, and then determine whether any available area for positioning, or repositioning, self-view content 304 may be found. Examples of this approach are described in FIG. 7-8.

In an embodiment, a plurality of available area 412 is identified in display 300. For example, a computer system may determine that two (or more) available areas 412a and 412b (not depicted in FIG. 4) are available on display 300. In this example, the computer system may check if both available areas 412a and 412b are large enough for displaying self-view content 304. If none of the available areas 412a and 412b is large enough for displaying self-view content 304, then the computer system may resize or crop any of the displayed contents. However, if one of available areas 412a and 412b is large enough for displaying self-view content 304, then the computer system may position, or reposition, self-view content 304 to one of the available areas 412a or 412b. If both available areas 412a and 412b are large enough for displaying self-view content 304, then the computer system may use various criteria to select one of them and position, or reposition, self-view content 304 in the selected available area. The criteria may include criteria that are purely preferential or economical. For example, if both available areas 412a and 412b are large enough for displaying self-view content 304, the computer system may select one of available areas 412a, 412b that is closer to a lower right corner of display 300, or one that is closer in size to the size of self-view content 304.

FIG. 5 is a screen snapshot of display 300 of display device 112 that shows repositioning of self-view content 304 to available area 412b on display 300. Display 300 comprises shared content 302, self-view content 304 and additional content 306. In the depicted example, a computer system determined two available areas 412a and 412b that are available on display 300. The computer system may check if both available areas 412a and 412b are large enough for displaying self-view content 304. It appears that available area 412a may be too small for displaying self-view content 304. However, available area 412b may be large enough for displaying self-view content 304. Hence, as depicted in FIG. 5, the computer system may reposition self-view content 304 to available area 412b.

Once self-view content 304 is repositioned to available area 412b, self-view content 304 does not overlap shared content 302 or additional content 306 displayed in display 300.

4.1 Example of Displaying Self-View Content in Available Area

FIG. 6 illustrates a process for a dynamic content positioning, or repositioning, on a computer-generated display of a display device. The process may be applicable to both positioning of the content when the content has not been displayed on a display yet, and repositioning of the content when the content has been displayed on a display but it overlaps some other content.

In step 610, shared content between two or more computers is received by a computer device. Shared content may be shared content 302 described above, or any other shared content shared by users. A computer device may be any device, including any of computer devices 111, 115, described in FIG. 1.

Also in this step, the shared content may be displayed on a display of the computer device. An area in which the shared content is displayed is referred to as a shared area. A shared area may be determined by a sender of the shared content, by the content receiving device, by default settings on a server, or using any other method. For example, unless specified otherwise, the shared content may be displayed in a left upper portion of the display of the computer device and may fill up as much space of the display as needed.

In an embodiment, a shared area may be defined using metadata associated with shared content and provided to a computer device driving the display. A shared area may also be defined using metadata stored in the computer device. The metadata may be modified or otherwise altered before it is provided to the computer device.

In step 620, self-view content is received at a computer device. The self-view content, such as self-view content 304 described above, may be a self-view image of a user, or an avatar image selected by the user. The self-view may be a video signal captured by a camera coupled to the user's computer device. An area in which the self-view content may be displayed is referred to as a first area.

A first area in which self-view content may be displayed on a display of a computer device may be defined using metadata associated with the received self-view content, or otherwise determined by the computer device. The computer device may determine a first area by parsing the received metadata, or by referring to certain default parameters stored in association with self-view content. Default parameters for a first area may define for example, that the first area is located in a left lower corner of the display. Other methods of defining the first area may also be implemented.

In an embodiment, a computer device determines whether to display self-view content in a first area of a display. For example, the computer device may determine whether the first area would overlap any already displayed content, and whether the display includes some other, more suitable area for displaying self-view content. The tests are performed in step 630.

In step 630, a computer device determines whether a first area, in which self-view content could be displayed, overlaps any content already displayed on a display of the computer device. The computer device may check for example, whether the first area and a shared area, in which the shared content is displayed, have any common area, common pixels or common edges. This may be determined using any image or signal processing algorithm configured to detect overlapping spaces.

In an embodiment, not depicted in FIG. 6, a computer device displays self-view content in a first area before checking whether the first area overlaps any shared content. In this approach, it is possible that the displayed self-view content obscures some shared content, or some other objects already displayed on the display. If that is the case, then the computer device determines another location, referred to as an available area, for displaying the self-view content. Upon determining such an available area, the computer device repositions the self-view content from the first area to the available area. The side effect of this approach is that the display of the self-view content may be frequently shifted or moved from one location to another. This may cause a so called image “flapping.”

An image flapping occurs when one or more contents are repositioned within a computer-generated display too frequently to be acceptable to a user. For example, an image flapping occurs when a self-view image is repositioned from one location on the display to another location too frequently to the user's liking. This may happen when shared or non-shared contents change frequently in a short period of time, and so do the locations of displayed self-view content.

An undesirable flapping effect may be avoided by having a computer device delay displaying self-view content for the first time on a display, or by having a computer device delay displaying the self-view content even if there is a need to reposition the self-view content.

In an embodiment, a computer device tests whether a first area overlaps any contents already displayed on a display of a computer device before actually displaying self-view content in the first area. This approach may eliminate an image flapping effect.

In step 640, a computer device determines whether a first area of the display overlaps any other displayed content, such as shared content displayed in a shared area. In response to determining that the first area of the display overlaps the shared area, step 660 is performed. Otherwise, step 650 is performed, in which the self-view content is displayed in the first area of the display.

In step 660, a computer device determines whether a display includes an available area that does not overlap any other displayed content. An available area may include a white space of the display that is not used to display any content. An available area may also include an area that is uniformly shaded or colored, and thus appears to carry a relatively small level of detail or a relatively small amount of information.

In an embodiment, an available area may be determined using any type of image data processing methods. For example, an available area may be determined using a white space detection approach, a free space detection approach, a Gaussian blur method, a Sobel operator method, a medial filter method, a pixel-based analysis, or any other method derived for this purpose.

In step 670, a computer device determines whether one or more available areas that do not overlap any already displayed contents exist. If at least one available area exists, then step 680 is performed. Otherwise, step 690 is performed. Step 690 is described in FIG. 7. If more than one available area exits, then the computer device determines one of the available area and performs step 680.

In step 680, a computer device displays self-view content in an available area. Once the self-view content is displayed in the available area, the computer device proceeds to receiving another shared content in step 610, described above.

The process described in FIG. 6 captures a dynamic positioning, or repositioning, of self-view content on a display of a computer device in such a manner that the self-view content does not obscure already displayed other contents.

In an embodiment, a process of a dynamic positioning, or repositioning, of contents on a computer-generated display based on available display space is also applicable to situations where shared content changes in any way. For example, the process may be invoked when additional shared content is displayed on a computer-generated display, or when the already displayed shared content is resized, updated, or modified in any way.

A change in displayed shared content may also impact a location of a first area in which self-view content is to be displayed. In response to the change in the displayed shared content, a computer device may determine another available area and display the self-view content in the other available area. However, to avoid the image flapping described above, the computer device may postpone displaying the self-view content in the available area by a certain time period. The time period may be determined using a timer, and the self-view content may be displayed in the available area only after expiration of the timer. Introducing a timer is one of the approaches for eliminating the image flapping effect described above.

The process of a dynamic positioning, or repositioning, of contents on a computer-generated displays based on available display space may also be invoked when additional shared contents and/or non-shared contents are displayed on a computer-generated display. For example, if additional shared content is displayed on a display of a computer device, then it is possible that self-view content needs to be repositioned to a new available area. If the contents change frequently, then the image repositioning may cause an undesirable image flapping effect. To avoid that, a timer may be used to determine when the self-view content can be repositioned to another location on the display.

4.2 Example of Content Resizing

FIG. 7 illustrates a process for a dynamic content positioning, or repositioning, on a computer-generated display of a display device using a content resizing approach. Resizing in this context refers to making the content smaller by changing a resolution of the content, not by cropping a portion of the content.

Content may be resized by for example, scaling the content down, converting the content to the lower-resolution content, or any other type of shrinking of the content. Scaling the content down may include a horizontal scaling, a vertical scaling, a bidirectional scaling, a uniform scaling, a non-uniform scaling, or any other type of resizing of the content. Although the examples in this section refer to reducing the content in size, sizing up of the content may also be applicable in some situations.

The process starts in step 690, in which a computer device determined that no available area that does not overlap already displayed contents can be determined in a display space of a display device.

In step 710, a computer device determines whether self-view content can be reduced in size to self-view resized content. Determining whether self-view content can be resized may depend on a variety of factors. One factor is feasibility, which in this context means determining whether it is possible to resize the self-view content. For example, a computer device may test whether the self-view content is large enough that sizing the self-view content down to small resized content can produce content large enough that would be readable on the display.

Another factor is practicality, which in this context means determining whether self-view content is sufficiently important to a user to go through the trouble of resizing the content. For example, a computer device may generate a message for a user to ask the user whether the user wants the self-view content to be reduced in size. Depending on the user's answer, the computer device may determine whether the self-view content is sufficiently important to the user and whether the self-view content can be resized.

In an embodiment, self-view content is resized by producing a smaller version of the self-view content. Resizing of the self-view content is usually performed within certain limits so that the quality of the self-view resized content is not compromised. While resizing or reducing in size may be preferred to accommodate displaying both the self-view and shared content, reducing the self-view in size beyond certain limits may negatively impact the user's viewing experience.

Limits on content resizing may be imposed in a variety of ways. For example, self-view content may be reduced in size as long as the self-view resized content is not smaller than a certain size, or as long as the self-view resized content is not smaller than for example, 10% of the total display area.

In step 720, a computer device determines that self-view content can or cannot be resized. In response to determining that the self-view content can be resized to self-view resized content, the computer device proceeds to performing step 730, in which the computer device resizes the self-view content to self-view resized content, and if possible, displays the self-view resized content in an available area. Various ways of determining an available area are described in FIG. 6.

Self-view content may be resized to self-view resized content using any type of image or signal processing technique. For example, self-view content provided in form of a digital image may be reduced in size using any type of pixel-based image processing technique. If self-view content is provided in form of a video signal, then the self-view content may be reduced in size using any type of frame-based image processing technique.

Once self-view resized content is displayed in an available area, a computer device proceeds to performing step 755, in which the computer device starts processing newly received shared and/or non-shared contents.

However, if self-view content cannot be resized to self-view resized content, then in step 740, a computer device determines whether shared content can be resized to shared resized content. If two or more shared contents are displayed on a display, then in step 740, the computer device determines whether any of the two or more shared contents can be resized to provide shared resized contents.

In an embodiment, a computer device determines whether shared content can be resized. Similarly to resizing of self-view content, resizing of the shared content is usually within certain limits so that the quality of the displayed shared content is not compromised. For example, the shared content can be reduced in size as long as the shared resized content is not smaller than a certain size, or as long as the shared resized content is not smaller than for example, 90% of the total display area.

In step 750, a computer device determines that shared content can or cannot be resized. In response to determining that the shared content can be resized to shared resized content, the computer device proceeds to performing step 780, in which the computer device resizes the shared content to the shared resized content, and displays the shared resized content in a shared resized area. Otherwise, the computer device proceeds to performing step 755, described in FIG. 6.

Shared content may be resized to provide shared resized content using any type of image or signal processing technique, as those described for self-view content resizing.

A shared resized area may be determined by a computer device performing the resizing, by a sender of the shared content, by default settings on a server, or by using any other method. For example, a shared resized area may be positioned at a left upper portion of the display of the computer device.

In an embodiment, a shared resized area may be defined using metadata that a computer device associated with shared resized content. A shared resized area may also be defined using metadata stored in the computer device. The metadata may be modified or otherwise altered before it is provided to the computer device.

Once shared resized content is displayed in a shared resized area, a computer device proceeds to performing step 722, in which the computer device determines whether an available area exists on a display for displaying self-view image. Step 722 is depicted in FIG. 6.

However, if shared content cannot be resized to provide shared resized content, then a computer device proceeds to performing step 790 described in FIG. 8.

4.3 Example of Content Cropping

FIG. 8 illustrates a process for a dynamic content positioning, or repositioning, on a computer-generated display of a display device using a content cropping approach. Content cropping in this context refers to making the content smaller by deleting or removing one or more portions of the content. The difference between content cropping and content resizing is that the content cropping involves deleting/removing one or more portions of the content, while the content resizing does not.

Self-view content cropping may include cropping a top portion of self-view content so that self-view cropped content is shorter in size than the self-view content. Self-view content cropping may also include cropping both a left portion and a right portion of self-view content so that self-view cropped content is narrower than the self-view content. Self-view content cropping may also include cropping both a left portion and a top portion of self-view content so that self-view cropped content is shorter and narrower than the self-view content.

A content cropping approach may be useful in situations when resizing of, for example, self-view content cannot be performed because the self-view content cannot be scaled down in such a way that self-view resized content is readable. However, it might be possible to crop such self-view content by deleting for example, a top portion of the self-view content if the top portion merely contains a background for a self-view image. The resulting self-view cropped content may be both smaller in size than the self-view content and reasonably readable.

The process starts in step 790, in which a computer device determined that self-view content cannot be displayed in an available area on a display, and that for some reason, neither the self-view content nor shared content can be resized to fit the available area. For example, the computer device might have determined that the self-view content is larger than an available area found on the display, the self-view content cannot be scaled down because the self-view is already very small, and the shared content for some reason cannot be resized.

In step 810, a computer device determines whether self-view content can be cropped in any way to self-view cropped content.

Determining whether self-view content can be cropped may depend on a variety of factors. One factor is feasibility, which in this context means determining whether the self-view content includes any portion that can be cropped. For example, a computer device may test whether a top portion of the self-view content contains only background of the self-view, or whether a left portion or a right portion of the self-view content contains uniformly shaded rectangular areas. These areas may by portions of a background, not the actual self-view image, and thus these area may be cropped.

Another factor is practicality, which in this context means determining whether the self-view content is sufficiently important to a user to go through the trouble of cropping any portion of the self-view content. For example, a computer device may generate a message for a user to ask the user whether the user wants the self-view content to be cropped on either side. Depending on the user's answer, the computer device may determine whether the self-view content is sufficiently important to the user and whether the self-view content can be cropped.

In an embodiment, self-view content is cropped to self-view cropped content. Cropping of the self-view content is usually performed within certain limits so that the quality of the self-view cropped content is not compromised. While cropping the self-view content may be preferred to accommodate displaying both the self-view and shared content, cropping the self-view beyond certain limits may negatively impact the user's viewing experience.

Limits on content cropping may be imposed in a variety of ways. For example, self-view content may be reduced in size as long as the self-view cropped content is not smaller than a certain size, or as long as the self-view cropped content is not smaller than 10% of the total display area.

In step 820, a computer device determines that self-view content can or cannot be cropped. In response to determining that the self-view content can be cropped to self-view cropped content, the computer device proceeds to performing step 830, in which the computer device crops the self-view content to the self-view cropped content, and displays the self-view cropped content in an available area, if possible. Various ways of determining an available area are described in FIG. 6.

Self-view content may be cropped to self-view cropped content using any type of image or signal processing technique. For example, self-view content provided in form of a digital image may be cropped by determining one or more portions of the self-view content that may be cropped, and deleting those portions from the self-view content. This may be accomplished using any type of pixel-based image processing technique. If self-view content is provided in form of a video signal, then the self-view content may be cropped using any type of frame-based image processing technique.

Once self-view cropped content is displayed in an available area, a computer device proceeds to performing step 755, in which the computer device starts processing newly received shared and/or non-shared contents.

However, if self-view content cannot be cropped to self-view cropped content, then in step 840, a computer device determines whether shared content can be cropped to provide shared cropped content. If two or more shared contents are displayed on a display, then in step 840, the computer device determines whether any of the two or more shared contents can be cropped to shared cropped content.

In an embodiment, a computer device determines whether shared content can be cropped. Similarly to cropping the self-view content, cropping the shared content is usually within certain limits so that the quality of the displayed shared content is not compromised. For example, the shared content can be cropped as long as the shared cropped content is not smaller than a certain size, or as long as the shared cropped content is not smaller than 90% of the total display area.

In step 850, a computer device determines that shared content can or cannot be cropped. In response to determining that the shared content can be cropped to provide shared cropped content, the computer device proceeds to performing step 880, in which the computer device crops the shared content to the shared cropped content, and displays the shared cropped content in a shared cropped area. Otherwise, the computer device proceeds to performing step 755, described in FIG. 6.

Shared content may be cropped to provide shared cropped content using any type of image or signal processing technique described above.

A shared cropped area may be determined by a computer device once cropping shared content is determined. A shared cropped area may also be determined by a sender of the shared content, by default settings on a server, or by using any other method. The shared cropped content may be displayed in a shared cropped area positioned for example, at a left upper portion of the display of the computer device and may fill up as much space of the display as is needed to display the shared cropped content, or a portion thereof.

In an embodiment, a shared cropped area may be defined using metadata that a computer device associated with shared cropped content. A shared cropped area may also be defined using metadata stored in the computer device. The metadata may be modified or otherwise altered before it is provided to the computer device.

Once shared cropped content is displayed in a shared cropped area, a computer device proceeds to performing step 722, in which the computer device determines whether an available area exists on a display for displaying self-view image. Step 722 is depicted in FIG. 6.

4.4 Extensions

In an embodiment, a computer device receives not only shared content and self-view content, but also some additional contents. Examples of additional contents may include depictions of other users, additional shared content, additional self-view content, and similar contents. In some situations, the additional contents may obscure the already displayed shared content or self-view content, and thus there may be a need to reposition the additional content on a display to an area that does not obscure other contents.

In an embodiment, a process of a dynamic content positioning, or repositioning, to an available area on a computer-generated display is applicable to any type of shared and non-shared contents. For example, the process may be executed for self-view content and any additional content. The process may also be executed in parallel for both the additional content and the self-view content.

In an embodiment, a process of a dynamic content positioning, or repositioning, to an available area on a computer-generated display is applicable to additional shared content. Therefore, the process described in FIG. 6 may be extended to situations in which the additional content is repositioned to an available area. Example of this extension is depicted in FIG. 9.

FIG. 9 illustrates a process for a dynamic positioning, or repositioning, of additional content 306 on a computer-generated display 300 of a display device. In the depicted example, display device 112 displays shared content 302, self-view content 904 and additional content 306. It appears that self-view content 904 does not obscure shared content 302, and thus there is no need to reposition self-view content 904 to any other area within a display of display device 112.

However, additional content 306 appears to obscure at least a portion of shared content 302. Assuming that a user would like to see the entire shared content 302, the user might prefer that additional content 306 be moved to some other area on display 300 so that additional content 306 does not obscure shared content 302. Thus, the process may be executed to identify an available area 912 and to reposition additional content 306 to available area 912. As depicted in FIG. 9, available area 912 does not obscure shared content 302. In fact, available area 912 does not obscure any content displayed on a display of display device 112.

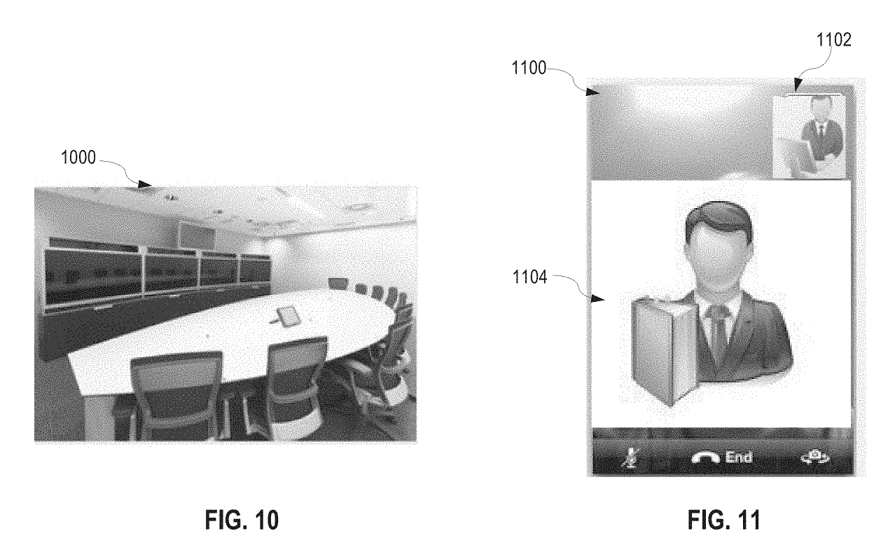

In an embodiment, a process of a dynamic content positioning, or repositioning, to an available area on a computer-generated display is applicable to a plurality of shared contents, a plurality of self-view contents, and/or a plurality of additional contents. This extension may be useful in collaborations sessions used by many users from many sites and equipped with many display devices. Example of such an arrangement is depicted in FIG. 10.

FIG. 10 is a picture 1000 showing a plurality of displays in which contents are dynamically positioned and repositioned. Each of the depicted display screens may be used to display shared and non-shared contents received from various computer devices and sites. The process of a dynamic content positioning and repositioning, described in FIG. 6, may be executed by each display device hosting the display screen, and with respect to each type of shared and non-shared contents.

In an embodiment, a process of dynamic content positioning, or repositioning, to an available area on a computer-generated display is implemented in a smartphone application executed on a smartphone device. For example, the process may be implemented in video chat applications, such as Facetime, executed on smartphones and other communications device. Example of a smartphone's implementation is depicted in FIG. 11.

FIG. 11 is a screen snapshot of a display 1100 of a smartphone that shows contents positioned using a process for a dynamic content positioning, or repositioning, on a computer-generated display of a display device. In FIG. 11, display 1100 includes a first user content 1102 and a second user content 1104. First user content 1102 may be captured by a camera installed in the smartphone used by a first user. Second user content 1104 may be generated and provided to display 1100 by a smartphone used by a second user. First user content 1102 may be self-view content of the first user and second user content 1104 may be a dynamically updated picture of the second user. As the two users talk over the phone, the contents provided to display 1100 may be positioned or repositioned using the approach described in FIG. 6. For example, if first user content 1102 appears to obscure or overlap second user content 1104, the process described in FIG. 6 may be used to reposition first user content 1102 to an available area that does not obscure the second user content 1104.

In an embodiment, a process of dynamic content positioning, or repositioning, to an available area on a computer-generated display is further extended to conference call applications in which more than two users participated in a call.

4.5 Benefits of Certain Embodiments

In an embodiment, an approach for a dynamic positioning, or repositioning, of content on a computer-generated display based on available space on the display enhances user's experience when a user uses computer-generated displays. Because self-view content is positioned on the display at a location that does not overlap or otherwise obscure other already displayed contents, the user may conveniently view both the shared contents and his self-view.

Furthermore, an approach for a dynamic positioning, or repositioning, of content on a computer-generated display based on available space on the display enhances the user's experience because an undesirable image flapping effect may be reduced, or even eliminated. The approach allows the computer system to determine the timing when self-view content needs to be repositioned to another location, when the self-view content needs to be displayed in a previous location, or when the self-view content needs to be eliminated from the display.

### 5.0 Implementation Mechanisms—Hardware Overview

According to one embodiment, the techniques described herein are implemented by one or more special-purpose computer devices. The special-purpose computer devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computer devices may also combine custom hard-wired logic, ASICs, or FPGAs with custom programming to accomplish the techniques. The special-purpose computer devices may be desktop computer systems, portable computer systems, handheld devices, networking devices or any other device that incorporates hard-wired and/or program logic to implement the techniques.

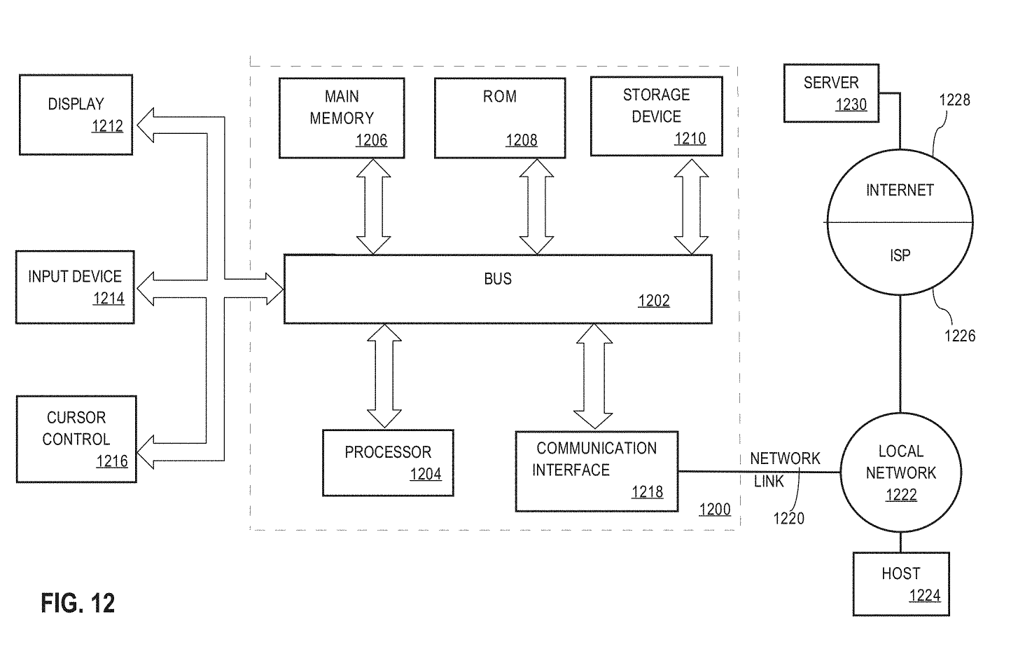

For example, FIG. 12 is a block diagram that illustrates a computer system 1200 upon which an embodiment of the invention may be implemented. Computer system 1200 includes a bus 1202 or other communication mechanism for communicating information, and a hardware processor 1204 coupled with bus 1202 for processing information. Hardware processor 1204 may be, for example, a general purpose microprocessor.

Computer system 1200 also includes a main-memory 1206, such as a random access memory (RAM) or other dynamic storage device, coupled to bus 1202 for storing information and instructions to be executed by processor 1204. Main-memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main-memory 1206. Such instructions may be read into main-memory 1206 from another storage medium, such as storage device 1210. Execution of the sequences of instructions contained in main-memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1210. Volatile media includes dynamic memory, such as main-memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main-memory 1206, from which processor 1204 retrieves and executes the instructions. The instructions received by main-memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server computer 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

### 6.0 Other Aspects of Disclosure

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer implemented method comprising:
receiving, at a first electronic device, shared content that a second electronic device has shared with a plurality of computer devices;
displaying the shared content on a display of the first electronic device in a shared area;
receiving, at the first electronic device, self-view content from a camera that is coupled to the first electronic device;
selecting a first area of the display of the first electronic device for displaying the self-view content;
determining whether the first area of the display of the first electronic device overlaps the shared area;
in response to determining that the first area overlaps with the shared area:
determining whether the display has an available different area that does not overlap the shared area;
in response to determining the available different area that does not overlap the shared area, displaying the self-view content in the available different area.

2. The method of claim 1, further comprising:
in response to determining that the available different area overlaps the shared area:
determining whether the self-view content can be resized to self-view resized content;
in response to determining that the self-view content can be resized to the self-view resized content, displaying the self-view resized content in the available area.

3. The method of claim 2, further comprising:
in response to determining that the self-view content cannot be resized to the self-view resized content:
determining whether the shared content can be resized to shared resized content;
in response to determining that the shared content can be resized to the shared resized content, displaying the shared resized content in a shared resized area.

4. The method of claim 3, further comprising:
in response to determining that the shared content cannot be resized to the shared resized content:
determining whether the self-view content can be cropped to self-view cropped content;
in response to determining that the self-view content can be cropped to the self-view cropped content, displaying the self-view cropped content in a self-view cropped area.

5. The method of claim 4, further comprising:
in response to determining that the self-view content cannot be cropped to the self-view cropped content:
determining whether the shared content can be cropped to shared cropped content;
in response to determining that the shared content can be cropped to the shared cropped content, displaying the shared cropped content in a shared cropped area.

6. The method of claim 5, further comprising, in response to determining that the shared content cannot be cropped to the shared cropped content, displaying the self-view content in the first area as overlapping the shared content displayed in the shared area.

7. The method of claim 1, wherein the shared content is a signal generated by one or more of: a videoconference application, a picture-in-picture application, a video collaboration application, a mobile calling application, a video and audio collaboration application, or a shared desktop application;
wherein the shared content is provided from one or more computer devices.

8. The method of claim 1, wherein the self-view content is a signal representing one or more of: a self-view, an animation, or a particular image.

9. The method of claim 1, wherein the available area is determined using one or more of: a white space detection, a free space detection, a Gaussian blur method, a Sobel operator method, a medial filter method, or a pixel-based analysis.

10. The method of claim 1, wherein the first electronic device is any one of: a desktop computer, a smartphone, a laptop, a personal digital assistant, or a computer device.

11. A non-transitory computer-readable storage medium storing one or more instructions which, when executed by one or more processors, cause the one or more processors to perform:
receiving, at a first electronic device, shared content that a second electronic device has shared with a plurality of computer devices;
displaying the shared content on a display of the first electronic device in a shared area;
receiving, at the first electronic device, self-view content from a camera that is coupled to the first electronic device;
selecting a first area of the display of the first electronic device for displaying the self-view content;
determining whether the first area of the display of the first electronic device overlaps the shared area;
in response to determining that the first area overlaps with the shared area:
determining whether the display has an available different area that does not overlap the shared area;
in response to determining the available different area that does not overlap the shared area, displaying the self-view content in the available different area.

12. The non-transitory computer-readable storage medium of claim 11, storing additional instructions, which cause:
in response to determining that the available different area overlaps the shared area:
determining whether the self-view content can be resized to self-view resized content;
in response to determining that the self-view content can be resized to the self-view resized content, displaying the self-view resized content in the available area.

13. The non-transitory computer-readable storage medium of claim 12, storing additional instructions, which cause:
in response to determining that the self-view content cannot be resized to the self-view resized content:
determining whether the shared content can be resized to shared resized content;
in response to determining that the shared content can be resized to the shared resized content, displaying the shared resized content in a shared resized area.

14. The non-transitory computer-readable storage medium of claim 13, storing additional instructions, which cause:
in response to determining that the shared content cannot be resized to the shared resized content:
determining whether the self-view content can be cropped to self-view cropped content;
in response to determining that the self-view content can be cropped to the self-view cropped content, displaying the self-view cropped content in a self-view cropped area.

15. The non-transitory computer-readable storage medium of claim 14, storing additional instructions, which cause:
in response to determining that the self-view content cannot be cropped to the self-view cropped content:
determining whether the shared content can be cropped to shared cropped content;
in response to determining that the shared content can be cropped to the shared cropped content, displaying the shared cropped content in a shared cropped area.

16. The non-transitory computer-readable storage medium of claim 15, storing additional instructions, which cause: in response to determining that the shared content cannot be cropped to the shared cropped content, displaying the self-view content in the first area as overlapping the shared content displayed in the shared area.

17. The non-transitory computer-readable storage medium of claim 11, wherein the shared content is a signal generated by one or more of: a videoconference application, a picture-in-picture application, a video collaboration application, a mobile calling application, a video and audio collaboration application, or a shared desktop application;
wherein the shared content is provided from one or more sources.

18. The non-transitory computer-readable storage medium of claim 11, wherein the self-view content is a signal representing one or more of: a self-view, an animation, or a particular image.

19. A computer implemented method comprising:
receiving, at a first computer, shared content that a second computer has shared with a plurality of computers that are involved in a video conference;
displaying the shared content on a display of the first computer in a shared area;
receiving, at the first computer, self-view image content from a camera that is coupled to the first computer;
selecting a first area of the display of the first computer;
determining whether the first area overlaps the shared area;
in response to determining that the first area overlaps the shared area, determining whether the display has an available area that does not overlap the shared area and that has a specified size, and in response to determining the available area that does not overlap the shared area and has the specified size, displaying the self-view image content in the available area.

20. The method of claim 19, further comprising, in response to a change in the shared content that causes the available area to overlap the changed shared content, determining another available area and displaying the self-view image content in the another available area only after expiration of a timer having a specified time value.
